(19) United States
(12) Patent Application Publication
(10) Pub. No.: US 2019/0372756 A1
(43) Pub. Date: Dec. 5, 2019

(54) Method for managing content based on blockchain and system for performing the method

(71) Applicant: KOREA INSTITUTE OF SCIENCE AND TECHNOLOGY, Seoul (KR)

(72) Inventors: Suhyun KIM, Seoul (KR); Gyuwon SONG, Seoul (KR)

(73) Assignee: KOREA INSTITUTE OF SCIENCE AND TECHNOLOGY, Seoul (KR)

(21) Appl. No.: 16/163,761

(22) Filed: Oct. 18, 2018

(30) Foreign Application Priority Data
May 30, 2018 (KR) 10-2018-0061686

(51) Int. Cl. H04L 9/06; G06F 17/30; H04L 9/32; H04L 9/08

(52) U.S. Cl. CPC H04L 9/0643; G06F 17/30194; H04L 2209/38; G06F 17/3023; H04L 9/0863; H04L 9/3263

(57) ABSTRACT

Exemplary embodiments relate to a method for managing content based on blockchain using a blockchain network including at least one node and a system for performing the method, each node including an offline storage and a blockchain distributed storage to store a blockchain, the method including synchronizing, by a first node, a folder in the offline storage to the blockchain distributed storage, detecting raw data corresponding to content of a content file stored in the folder and determining version data of the content, generating a metadata set of the content file based on the version data, determining data for blockchain storage based on the version data and the metadata set and encrypting the data for blockchain storage, and storing transaction including the encrypted data in the blockchain.

### CROSS-REFERENCE TO RELATED APPLICATION

This application claims priority to Korean Patent Application No. 10-2018-0061686, filed on May 30, 2018, and all the benefits accruing therefrom under 35 U.S.C. § 119, the contents of which in its entirety are herein incorporated by reference.

### STATEMENT REGARDING SPONSORED RESEARCH

This study was supported by the Institute for information & communications Technology Promotion of Korea (Project Name. Technical development of Predictive analysis for Social change using Self-Evolving agent simulation based on Gradual machine learning, Project No. 1711065140) under the superintendence of Ministry of Science and ICT, Republic of Korea.

### BACKGROUND

### 1. Field

The present disclosure relates to blockchain based content management, and more particularly, to a method for managing content based on blockchain, in which a content file containing content (e.g., research-related content such as a research note) in the form of data is stored and managed in blockchain in the process of applying modification to the content file one or more times, and a system for performing the method.

### 2. Description of the Related Art

Researchers who conduct a specific research may write research notes to record the results obtained in the research process. Recently, because writing research notes is very helpful for researchers, writing and managing research notes is essentially required in conducting research.

Writing and managing research notes provides various advantages. For example, writing and managing research notes provides advantages in the following aspects: prevention of forgetting of the research details and research efficiency improvement, reporting of the research process to the research sponsor (e.g., employer, investor, government, etc.), conflict prevention to avoid any future conflict (e.g., unfair competition prevention and business secrets protection, proof of employee invention, etc.), and research ethics verification for verifying the truth of the research results.

Accordingly, writing and managing research notes is very important. The standards for public confidence in research notes include the requirements of electronic research notes, the use of electronic research notes, and the standards for using electronic research notes as evidence. The requirements of electronic research notes include authenticatable signatures of recorders and examiners of electronic research notes, automatic recording of the date and time at which research records are inputted, and permanent recording of modification details of the inputted records. The use of electronic research notes includes recording and storing the contents and data of the research in the form of an electronic document, using when the necessity of sharing is high, using and working with the research and performance management system, and matching the writing methods and writing principles for each item with the written research notes. The standards for using as evidence includes inputting the research records at the point in time the research was made or when not much time has elapsed, recording by input or transmission from persons having knowledge about the research, and validating the foregoing by electronic research note recording and input software or hardware managers used.

FIG. 1 is a diagram showing an exemplary display used to write a research note. As shown in FIG. 1, electronic research note services are now provided through various solutions that conform to the above-described standards. However, all functions of the current electronic research note services are dependent on research note service providers. Due to this problem, poor version management of electronic research note services of service providers may cause inconvenience to users. Additionally, there is a limit to the user's dealing with failure occurred in the service provider's system, and data may be permanently damaged.

Additionally, it is necessary to separately register files to attach, and in this process, essential contents may be omitted, and when it is repeated each time, users may feel inconvenient. To write papers and reports, it is necessary to write the same content again using different document programs.

Further, collaboration such as writing research notes together with external researchers of external research institutions is limitative. Particularly, in the case of an electronic research note service requiring Korean certified authentication, there is a limitation that it is almost impossible for foreign researchers to participate.

### RELATED LITERATURES

### Patent Literatures

(Patent Literature 1) Patent Publication No. 10-2013-0120734

### SUMMARY

The present disclosure is directed to providing a method for managing content based on blockchain, in which content to which modification is applied once or more times is stored and managed in blockchain, and a system for performing the method.

In a method for managing content based on blockchain using a blockchain network including at least one node according to an aspect of the present disclosure, each node including an offline storage and a blockchain distributed storage to store a blockchain in which blocks are linked together, the method includes synchronizing, by a first node, a folder in the offline storage to the blockchain distributed storage, detecting raw data corresponding to content of a content file stored in the folder and determining version data of the content, generating a metadata set of the content file based on the version data, determining data for blockchain storage based on the version data and the metadata set and encrypting the data for blockchain storage, and storing transaction including the encrypted data in the blockchain.

In an embodiment, the determining the version data may include, when a predetermined command for the content file is received, comparing content files before and after the command—the comparing is performed by comparing first raw data corresponding to the content before the command with second raw data corresponding to the content after the command, when there is no difference between the first raw data and the second raw data, detecting the first raw data and determining it to be version data, and when there is a difference between the first raw data and the second raw data, detecting data corresponding to the raw data difference before and after the command and determining it to be version data.

In an embodiment, when there is a difference between the first raw data and the second raw data, the metadata set of the content file after the command may be updated based on the version data of the difference between the first raw data and the second raw data.

In an embodiment, a block including the transaction related to the version data before the command may be different from a block including the transaction related to the version data after the command.

In an embodiment, the method may further include, when a command for executing the content file is received, retrieving transaction related to the content file from the blockchain, decrypting encrypted data included in the found transaction, and executing the content file using the decrypted data.

In an embodiment, the executing the content file may include, in the case of one or more found transactions, executing the content file by combining version data of each transaction.

In an embodiment, the encrypting may include encrypting for verification.

In an embodiment, each node may have a private key and a public key, and the encrypting for verification may include encrypting the data for blockchain storage using the private key.

In an embodiment, the encrypting may include encrypting for confidentiality.

In an embodiment, the encrypting for confidentiality may include encrypting using a password preset for each node.

In an embodiment, the method may further include providing, by the first node, an authority to use the encrypted data for confidentiality to the second node.

In an embodiment, the second node may be located in a foreign country.

In an embodiment, the data for blockchain storage may include version data.

In an embodiment, the metadata set may include basic metadata. Here, the basic metadata may include a file owner, a file path on the offline storage, generation time and access authority.

In an embodiment, the metadata set may include content metadata. Here, the content metadata may be detected from the content of the content file by a content analysis model.

In an embodiment, the content analysis model may be based on rapid automatic keyword extraction (RAKE) or Term Frequency-Inverse Document Frequency (TF-IDF).

In an embodiment, the storing in the blockchain may include recording the transaction in an available block included in the blockchain, and disseminating the transaction to a second node.

In an embodiment, the data for blockchain storage may further include access data for access to the version data.

In an embodiment, the method may further include uploading the version data to a database node.

A non-transitory computer-readable recording medium according to another aspect of the present disclosure can be read by a computer and stores a program command that can run by the computer. Here, when the program command is executed by a processor of the computer, the processor performs the method according to the above-described embodiments.

In a system for managing content based on blockchain using a blockchain network including at least one node according to still another aspect of the present disclosure, each node includes a data processing module, a blockchain execution module, an offline storage and a blockchain distributed storage to store a blockchain in which blocks are linked together, and is configured to perform the steps of detecting, by the data processing module, raw data corresponding to content of a content file stored in the folder and determining version data of the content, and generating a metadata set of the content file based on the version data, and determining, by the blockchain execution module, data for blockchain storage based on the version data and the metadata set and encrypting the data for blockchain storage, and storing transaction including the encrypted data in the blockchain.

The method for managing content based on blockchain according to an aspect of the present disclosure stores content-related data in blockchain, allowing for digital authentication and permanent data storage. Particularly, in the data security aspect, integrity verification is possible. Accordingly, it can be used to create research-related information that plays a role in ethical verification of authors and prevention of conflicts associated with the results.

Furthermore, because the results are stored in folders synchronized to blockchain, separate file uploading is not required and the user convenience is maximized. Additionally, metadata of content files can be generated using machine learning. Further, the Single point of Failure problem can be solved due to the distributed nature of blockchain.

Additionally, dissemination of transactions through blockchain allows participants in the system to share the content. In case that the content is treated with confidentiality, only if authority is given, access is allowed. Accordingly, collaboration such as writing research notes by authors (or groups to which the authors belong) together with external users is made easy. Particularly, because Korean certified authentication is not required each time the research note is used, it is very easy for foreign researchers to participate.

Further, in research-related information containing the records of the research process, a predetermined portion should be preserved as know-how, so confidentiality is set to keep it confidential, and a predetermined portion is selectively set to be public for paper presentation or reporting to external institutions. Accordingly, particular content files can act as an online journal through sharing of results.

The effects of the present disclosure are not limited to the above-mentioned effects, and other effects not mentioned herein will be clearly understood by those skilled in the art from the appended claims.

### BRIEF DESCRIPTION OF THE DRAWINGS

To describe the technical solution of the embodiments of the present disclosure or related art more clearly, drawings necessary for description of the embodiments is introduced in brief below. It should be understood that the accompanying drawings are only provided to describe the embodiments of the present disclosure and are not intended to be limiting. Additionally, for clarity of description, certain elements to which various modifications such as exaggeration and omission are applied may be shown in the accompanying drawings.

FIG. 1 is a diagram showing an exemplary display used to write a research note.

FIG. 2 is a conceptual architecture diagram of a system for performing a method for managing content based on blockchain according to an embodiment of the present disclosure.

FIG. 3 is a flowchart of a method for managing content based on blockchain according to an embodiment of the present disclosure.

FIG. 4 is a diagram illustrating an example in which sync folder is used according to an embodiment of the present disclosure.

FIGS. 5A and 5B are diagrams illustrating a process of storing a content file before modification in blockchain according to an embodiment of the present disclosure.

FIGS. 6A and 6B are diagrams illustrating a process of storing the content file of FIG. 5 after modification in blockchain according to an embodiment of the present disclosure.

FIG. 7 is a diagram exemplarily showing a blockchain in which content-related data before and after modification is stored according to an embodiment of the present disclosure.

FIG. 8 is a diagram illustrating an example of use of content-related data stored in blockchain according to an embodiment of the present disclosure.

FIG. 9 is a diagram illustrating an example of use for publication of a file stored in blockchain according to an embodiment of the present disclosure.

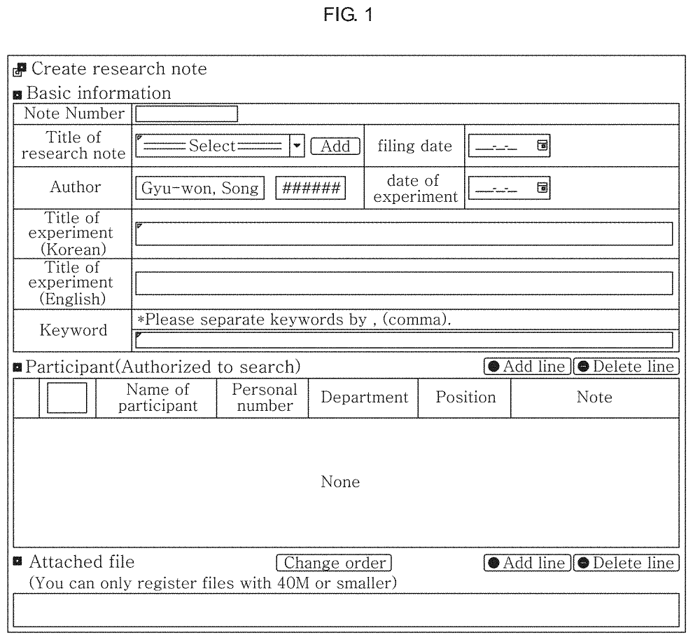

### DETAILED DESCRIPTION

The terminology used herein is for the purpose of describing particular embodiments only and is not intended to be limiting of the present disclosure. As used herein, the singular forms are intended to include the plural forms as well, unless the context clearly indicates otherwise. The term “comprises” when used in this specification, specifies the presence of stated features, regions, integers, steps, operations, elements and/or components, but does not preclude the presence or addition of one or more other features, regions, integers, steps, operations, elements and/or components.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

The term “content” as used herein is implemented by execution of a content file, and is implemented as text, images, videos, audios, graphics and other content types. Hereinafter, for clarity of description, the present disclosure is described based on embodiments in which multiple modifications are applied to research conducted for one or more days, and a “research note” implemented as text, images and/or videos is applied as an example of content.

The term “node” as used herein is a blockchain network participant, and includes a variety of electronic devices capable of communication, for example, a server, a personal computer, a smartphone and a terminal.

Hereinafter, the embodiments of the present disclosure will be described in detail with reference to the accompanying drawings.

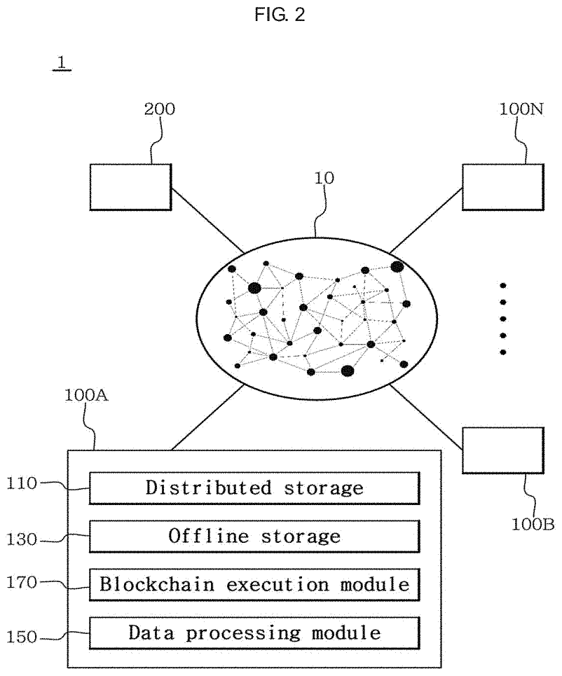

FIG. 2 is a conceptual architecture diagram of a system for performing a method for managing content based on blockchain according to an embodiment of the present disclosure.

Referring to FIG. 2, the system for performing a method for managing content based on blockchain (hereinafter, “system for managing content based on blockchain”) 1 is a system using a blockchain network 10 including at least one node 100A, 100B, . . . , 100N, and each node 100A, 100B, . . . , 100N includes a distributed storage 110, an offline storage 130, a data processing module 150 and a blockchain execution module 170.

The system 1 for managing content based on blockchain according to the embodiments may have aspects of entirely hardware, entirely software, or partly hardware and partly software. For example, an identification device 1 may refer collectively to hardware with the data processing ability and operating software that operates it. The term “unit”, “module”, “device”, or “system” as used herein is intended to refer to a combination of hardware and software that runs by the corresponding hardware. For example, hardware may be a data processing device including a Central Processing Unit (CPU), a Graphic Processing Unit (GPU) or other processor. Additionally, software may refer to a process in execution, an object, an executable, a thread of execution and a program.

Here, the blockchain network 10 is a network of nodes designed to use the blockchain as a distributed ledger. The distributed ledger is the ledger, a record of transaction information, which is distributed over a peer-to-peer network, not a central server of a particular institution, and is collaboratively recorded and managed by members. Each member (i.e., node) of the blockchain network 10 agrees on the ledger content (generally, transaction) using a consensus protocol. The blockchain network 10 records transactions on which all nodes agreed in chronological order, and once the transaction is stored in blockchain, the record of transaction cannot be altered. Additionally, the blockchain network 10 uses digital signature based on PKI algorithm to ensure the integrity of transactions.

Here, the blockchain refers to a data structure in which transactions are grouped at a predetermined time interval to generate a block, and the block is continually connected to the previously generated block like a chain. The blocks may include various types of information. In certain embodiments, the blocks may include a block hash value and a nonce value of the corresponding block and a block hash value of the previous block. The hash value and the nonce value are values obtained using a preset hash function. Additionally, the blocks may include information associated with software that operates the system 1, block generation time and information associated with the node 100 (e.g., an IP address of the node 100, etc.).

The blockchain is stored in the blockchain distributed storages (hereinafter, “distributed storages”) 110 of each node included in the blockchain network 10. The distributed storages 110 of each node are a predetermined storage space for storing blockchain results generated by the blockchain network in each node in distributed manner, and refers to storage components that make up the entire distributed storage of the blockchain network 10. The data stored in blockchain is disseminated to other nodes through the blockchain network 10, and the data dissemination results are stored in the nodes again. After the dissemination results are disseminated to all nodes, blockchains stored in the distributed storages 110 of each node are substantially the same and thus they are eligible to verify the validity of the disseminated data. Unless specified otherwise in the specification, storing in the blockchains of the distributed storages 110 of each node 100 is described as storing in the blockchain of the blockchain network 10.

The offline storage 130 is a memory module in which the data and/or files of the node 100 can be stored offline. The data and/or files received (e.g., inputs, dissemination, etc.) at the node 100 are generated and stored in the offline storage 130.

The offline storage 130 and the blockchain distributed storage 110 of the node 100 are not necessarily intended to refer to separate storage components that are physically distinct from each other. That is, a device (i.e., the node 100) in which they are implemented is only functionally divided according to the operation performed in the device, and each storage does not need to be provided as an independent component.

It will be obvious to those skilled in the art that the system 1 and/or the node 100 may include other components not described herein. For example, the system 1 and/or the node 100 may include other hardware elements necessary for the operation described herein, including network interfaces, input devices for data entry, and output devices for displaying, printing or other type of data displaying.

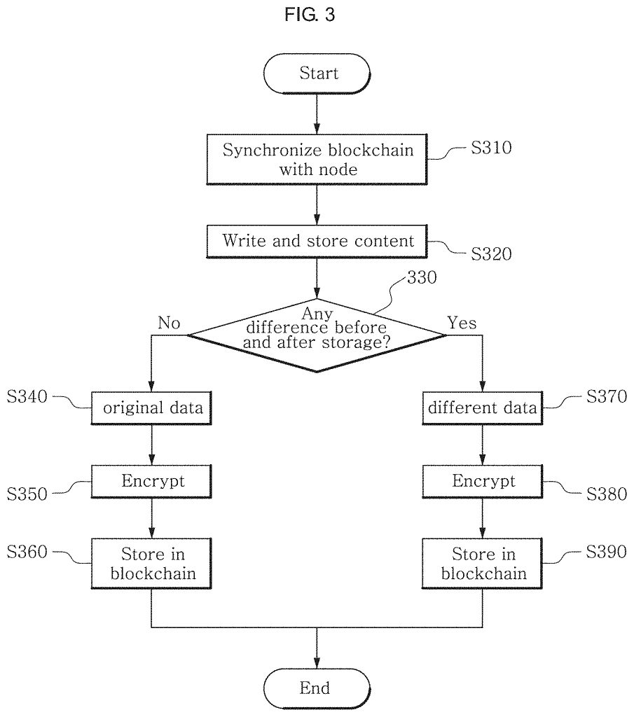

FIG. 3 is a flowchart of the method for managing content based on blockchain according to an embodiment of the present disclosure.

Referring to FIG. 3, the node 100A registered in the blockchain network 10 synchronizes a folder in the offline storage 130 to the blockchain distributed storage (S310).

In an embodiment, the data processing module 150 of the node 100A sets a particular folder for writing a research note as a sync folder of the system 1 to synchronize a particular folder in the offline storage 130 with the distributed storage 110. Accordingly, even though data or a file is generated in the sync folder located in the offline storage 130, there is no need to separately move the corresponding data or file to the distributed storage 110. Further, the node 100A may track all changes of the sync folder, and the changes are automatically stored in blockchain. Accordingly, the node 100A may automatically provide a file stored in the offline storage 130 of the node 100A to the blockchain network 10.

The synchronization is performed based on the path of the sync folder. Accordingly, when a subfolder is generated in the sync folder by the data processing module 150, the subfolder is also synchronized to the distributed storage 110.

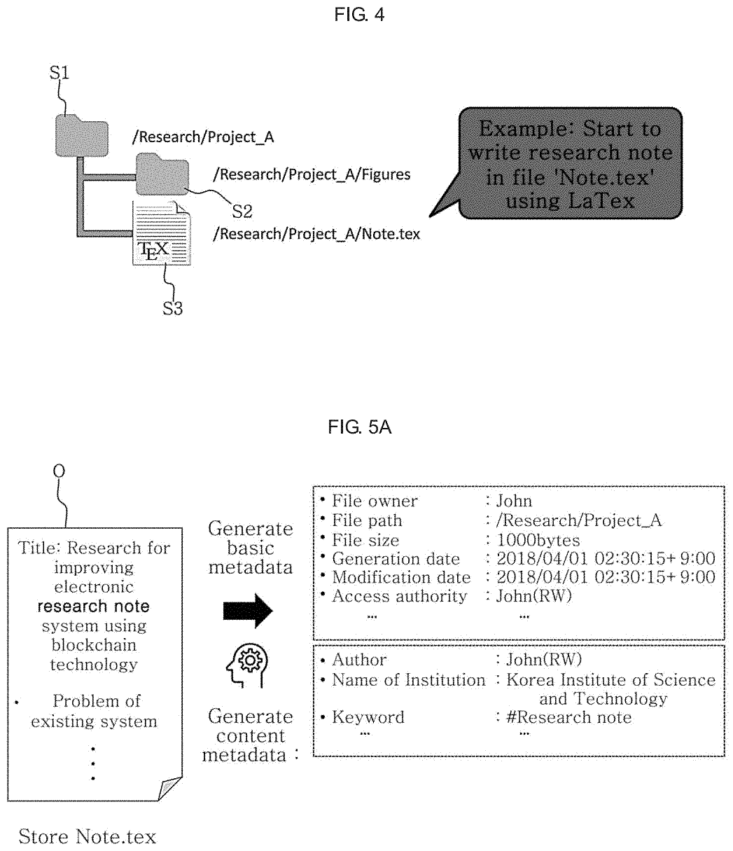

FIG. 4 is a diagram illustrating an example of use of the sync folder according to an embodiment of the present disclosure.

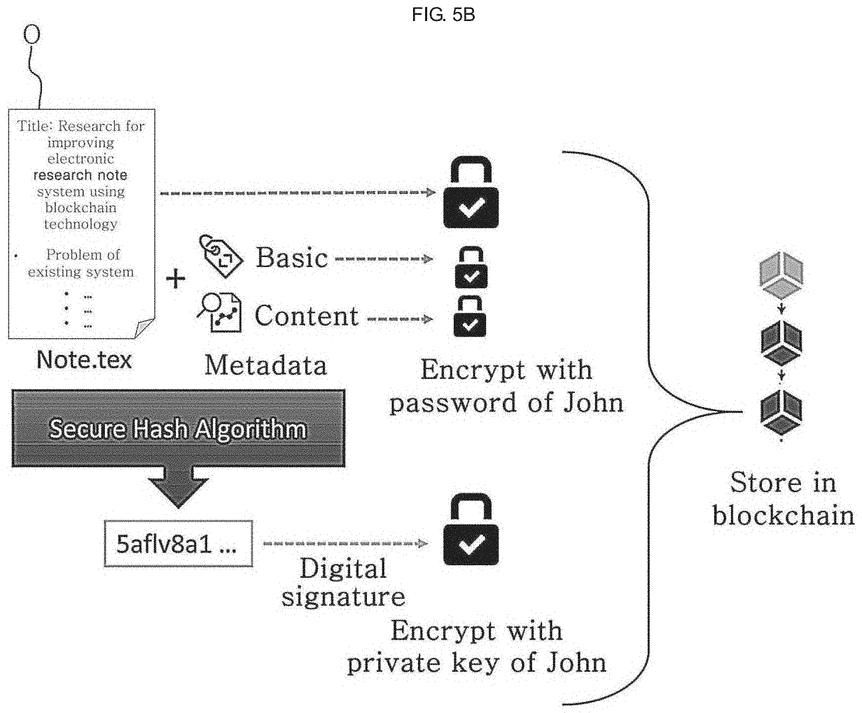

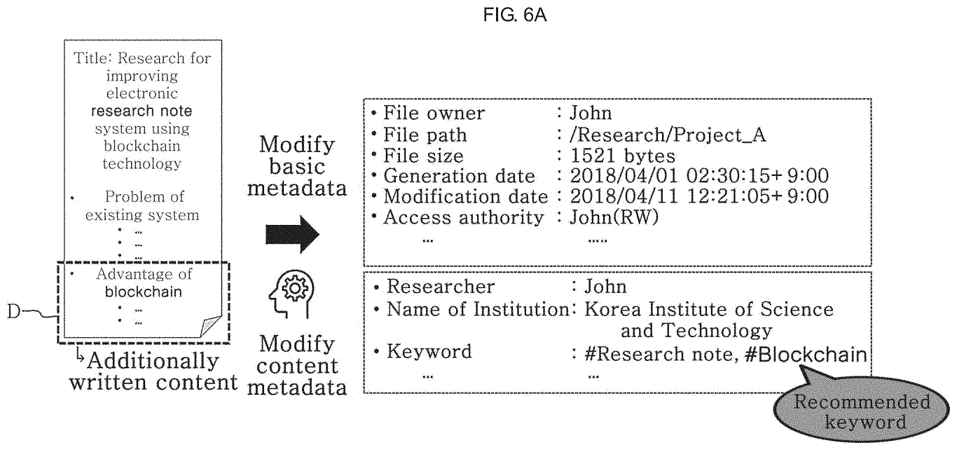

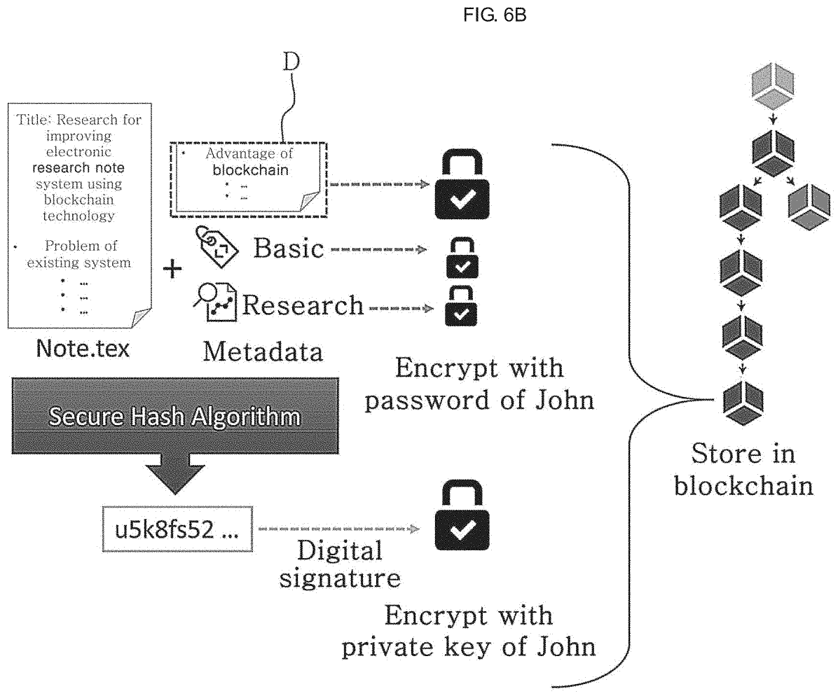

Referring to FIG. 4, the data processing module 150 of the node 100A sets a folder “Research” (path: /Research) S1 as a sync folder, and synchronizes the folder “Research” S1 to the distributed storage 110 using the path of the corresponding folder. Subsequently, when a subfolder (e.g., a folder “Figures” S2 in FIG. 4) of the folder “Research” S1 is generated, the subfolder is also additionally synchronized to the distributed storage 110. After synchronization setting, when the content of a file (e.g., a file “Note” S3 in FIG. 4) located in the folder “Research” S1 is stored, data corresponding to the content of the file “Note” is automatically stored in blockchain of the distributed storage 110 in response to the storage command. It will be described in more detail with reference to FIGS. 5 and 6 below.

In an embodiment, the node 100A may be required to register in the blockchain network 10 before synchronization. For example, an application for operating the system 1 is installed in the node 100A, and a user account is generated and registered using various identity authentication methods (e.g., including e-mail authentication, mobile phone authentication, credit card authentication, etc.). In certain embodiments, the system 1 may include a manager node (not shown) for registration. In other embodiments, the manager node may serve as both a manager for registration and a user node.

When registration of the node 100A is finished, the node 100A may be provided with information for research note encryption, for example, a public key, a private key and a password. Additionally, the node 100A may be provided with its account's identifier.

After synchronization S310, the user may write a research note in the sync folder and store it as a file (S320). The file can be modified, and the content of the research note is written based on a writing tool (e.g., MS word, Arae-Ah Hangul, LaTex, Markdown, etc.) suitable for writing research notes and is stored. Writing the content is performed by the user's input command or information reception after file generation, and after writing, the file includes raw data corresponding to the written content.

In an embodiment, the data processing module 150 may allocate an identifier to the generated sync folder and/or file. The identifier may be used for a history of continuous modifications of the file.

When the command to store the content of the research note is received, the node 100A stores the content of the research note of the research note file in the sync folder. In response to storage of the sync folder, the content of the corresponding research note is stored in blockchain.

The data processing module 150 pre-processes data of the content stored in the sync folder before storing data corresponding to the content of the research note in blockchain, to allow the system 1 to efficiently perform the task of storing the content of the research note in blockchain and the task of implementing the stored research note.

In an embodiment, the data processing module 150 detects raw data corresponding to the content of the research note of the research note file stored in the sync folder and determines version data of the content of the research note.

The version data is generated, corresponding to the point in time the content file is stored. The data processing module 150 compares raw data before and after storage, and when any change occurs in the raw data, generates new version data of the research note file after storage. For example, when the task of modifying and storing the research note file is completely performed at the first time, first version data is determined, and when the task of modifying and storing the same file is performed at the second time, second version data is determined.

As described above, because the version data is related to the point in time the content file is stored after modification, when intending to implement a content file corresponding to a particular point in time (e.g., when intending to implement the research note file stored in the first point in time), the system 1 may perform such an implementation based on the content file of the first point in time and/or the previous point in time. Additionally, it is not limited to simply identifying the point in time of the content file in relation to modification and storage, and may be used to identify the point in time another data related to modification and storage of the content file is generated. For block data and transaction related to a particular point in time, for example, it may be used to identify the point in time. It will be described in more detail with reference to FIGS. 5 and 6 below.

When the storage command for the research note file is received, the data processing module 150 compares the research note files before and after the command (S330). The above S330 is performed by comparing first raw data corresponding to the content of the research note before storage and second raw data corresponding to the content of the research note after the command and determining if there is a difference between the first raw data and the second raw data.

The next step after storing the content of the research note in blockchain may be differently performed depending on whether the research note file is modified or not. Hereinafter, the operation of the data processing module 150 of the node 100A depending on whether modification is applied to the research note file will be described in more detail with reference to FIGS. 5 and 6.

FIGS. 5A and 5B are diagrams illustrating a process of storing a content file before modification in blockchain according to an embodiment of the present disclosure, and FIGS. 6A and 6B are diagrams illustrating a process of storing the content file of FIG. 5 after modification in blockchain according to an embodiment of the present disclosure. To description modification and non-modification more clearly, modification occurring in the process of inputting and storing the content shown in FIG. 5A after initial generation of a research note file is neglected. Eventually, FIG. 5A is regarded as having no modification.

Referring to FIG. 5A, when the content of the research note ‘research for improving the research note system using blockchain technology’ is written and stored in the research note file, the data processing module 150 stores raw data O corresponding to the content of the research note according to the storage command.

When there is the storage command at the first time, the data processing module 150 compares the research note files before and after storage (S330). In the above S330, first raw data corresponding to the content before the command is compared with second raw data corresponding to the content after the command. When there is no difference between the first raw data and the second raw data, the first raw data is detected and determined to be version data (S340).

Because modification is not applied to the research note file of FIG. 5A, there is no change. Accordingly, first raw data or raw data O is determined to be first version data (S340). Subsequently, the data processing module 150 stores the content of the research note stored at the first time in blockchain based on the first version data.

In addition, the data processing module 150 generates a metadata set of the content file based on the version data. The metadata set includes basic metadata and content metadata.

Here, the basic metadata is metadata associated with basic data of the research note file, and for example, includes a file owner, a file path on offline storage, generation time and access authority as shown in FIG. 5.

The content metadata includes a content field-related keyword, for example, in the case of a research note, a research-related keyword. In an embodiment, the content metadata is detected from the raw data of the content file by a content analysis model. The content analysis model is based on a natural language processing algorithm with machine learning of the research-related keyword (i.e., the keyword related to the corresponding content field), and the natural language processing algorithm includes rapid automatic keyword extraction (RAKE), or Term Frequency-Inverse Document Frequency (TF-IDF). However, the natural language processing algorithm is not limited thereto, and includes a variety of natural language processing algorithms with machine learning of keywords related to the corresponding content field. In another embodiment, the content metadata may be generated by user input.

The blockchain execution module 170 determines the version data (i.e., the raw data O) and all or part of the metadata set to be data for blockchain storage. In an embodiment, the raw data O and the metadata set are determined to be data for blockchain storage as shown in FIG. 5B. The blockchain execution module 170 of the node 100A encrypts the version data and the metadata set (S350), and stores the encrypted data in blockchain (S360).

In an embodiment, the S350 of encrypting the data for blockchain storage such as the version data itself and the metadata set based on the version data includes encryption for verification. Additionally, in another embodiment, encryption for confidentiality may be further included.

Here, the encryption for verification describes the validity of the process of storing the data for blockchain storage in blockchain, and for example, refers to additionally generating a public key infrastructure (PKI) based digital signature based on the data for blockchain storage, and storing it in blockchain together with the data for blockchain storage. In an embodiment, the digital signature is generated by calculating a hash value of the data for blockchain storage by applying a hash function to the data for blockchain storage and applying a private key of the node 100A to the hash value of the data for blockchain storage to generate a digital signature for the data for blockchain storage of the node 100A.

After encryption for verification is performed in the S350, the blockchain execution module 170 stores, in blockchain, the digital signature and the data for blockchain storage for which the digital signature is verified.

In contrast, the encryption for confidentiality refers to encryption for limiting an access to the data for blockchain storage. For example, the encryption for confidentiality may be performed by additionally setting a password. In an embodiment, the encryption for confidentiality may prevent data leakage by the Advanced Encryption Standard (AES) method. In other embodiment, various encryption methods may be used to prevent data leakage and keep confidential.

When the encryption for confidentiality is not performed on a particular file, a user of other node of the blockchain network 10 may access the data for blockchain storage of the node 100A stored in blockchain and read or use the corresponding file. Accordingly, the encryption for confidentiality may be optionally applied to publish the particular file.

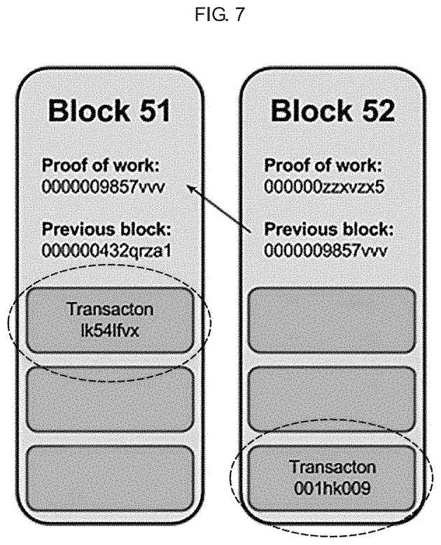

A specific example in which the encryption for verification and the encryption for confidentiality are used in the system 1 will be described in more detail with reference to FIG. 7 below.

In contrast, as shown in FIG. 6A, when the research note file of FIG. 5A is modified and stored at the second time, data corresponding to the content of the modified research note is added to the research note file. Then, as a result of comparison in the S330, a data difference before and after storage occurs, and raw data D corresponding to the data difference of the research note files before and after storage (i.e., corresponding to the change) is detected and determined to be second version data (S370).

Subsequently, the data processing module 150 generates a metadata set of the research note file further based on the second version data D corresponding to the data difference. In an embodiment, the data processing module 150 updates the metadata set generated based on the first version data O based on the second version data D so that the metadata set of the research note file of the second time reflects the content of the modified research note. Referring to FIG. 6A, metadata including the file size, the modification date and the keyword is updated by the raw data D corresponding to the additionally written content.

The blockchain execution module 170 determines the second version data D and all or part of the updated metadata set to be data for blockchain storage. In an embodiment, the second version data D and the updated metadata set may be stored in blockchain as data for blockchain storage as shown in FIG. 6B. The blockchain execution module 170 of the node 100A encrypts the second version data D and the metadata set (S380), and stores the encrypted data in blockchain (S390).

FIG. 7 is a diagram exemplarily showing the blockchain in which content-related data before and after modification is stored according to an embodiment of the present disclosure.

The storage of the encrypted data (S360 and S390) is performed by recording transaction including the encrypted data in a block of blockchain. Here, the block in which the transaction is recorded refers to a block in which an additional transaction may be recorded at the moment the transaction is generated.

In an embodiment, the available block refers to the next block to a validity verified block, generally called a candidate block. The verification of validity is determined by consensus of nodes. The consensus may be performed by various consensus algorithms.

In an embodiment, the verification of validity may be performed by the Proof of Work (PoW) method performed using a preset hash function. For example, the verification of validity may be performed by calculating a random nonce value with transaction received from other node using a preset hash function to make a hexadecimal block hash value satisfying a predefined number of ‘0’s. The system 1 uses the SHA 256 hash function, and any other hash function may be used. The reason to perform the verification of validity task is for making it impossible to know which of nodes participating in blockchain will generate a block, and an attack of the malicious node is prevented by keeping the malicious node from determining which node will generate a block at the present time. For example, the height of blockchain of bitcoin is 417453, the number of ‘0’s in the block hash value is 17, and bitcoin adjusts the block generation difficulty by increasing the number of ‘0’s, and sets the block generation difficulty by taking the number of ‘0’s that keeps generating one block every 10 minutes on the basis of the system having the highest CPU or GPU performance at the present time.

In other embodiments, the verification of validity may be performed using proof-of-stake (PoS), PAXOS, or Practical Byzantine Fault Tolerance (PBFT).

When one of nodes of the blockchain network 10 succeeds the verification of validity first, the blockchain execution module 170 finds the block hash value and the random Nonce value, generates a block using them, and transmits the block generation fact and the found block hash value and random nonce value to all nodes. In general, a node that succeeded in the verification of validity first is referred to as a mining node.

When the block hash value and the nonce value are received from the mining node, the blockchain execution module 170 determines the validity of the transaction and the received block hash value and nonce value using a validity verification algorithm, and when the verification of validity is finished, generates an additional block using the received block hash value and nonce value and connects the additional block to the blockchain. The additional block is an available block of the corresponding node.

Referring to FIG. 7, the content of the research note written in FIG. 5 is recorded in block (Block 51) as transaction, and the content written in FIG. 6A is recorded in block (Block 52) as transaction. The content of the research note written in different nodes (100B, . . . , 100N) may be stored and recorded in each block.

When the transaction is recorded, a history including identifiers, for example, the user (e.g., the research note author) of the node 100A, the file and the path may be generated and updated.

The node 100A executes the research note file and implements the research note using the data for blockchain storage related to the corresponding research note file. In an embodiment, when the command for executing the research note file is received, the node 100A retrieves transaction related to the corresponding research note file from the blockchain, and executes the research note file using data included in the found transaction. In an embodiment, in case that data included in the found transaction is encrypted, a task of decrypting the encrypted data is performed before execution.

The retrieval is similar to a process of calculating a remaining amount of a bitcoin wallet in typical applied blockchain technology, bitcoin technology. After retrieving transaction details related to an account of a bitcoin wallet based on a transaction history recorded in the corresponding bitcoin wallet, a remaining amount is calculated by calculating a transaction amount. As described above, the retrieval is performed to retrieve transaction related to the corresponding research note file based on the transaction history.

As a result of retrieval, the blockchain execution module 170 may acquire data included in the found transaction or additionally decrypted related data. When modification is applied to the research note file to which the execution command is targeted, the decrypted data includes first version data (i.e., all raw data of the research note file of the first point in time) and second version data (i.e., raw data corresponding to the modification details of the research note). When at least one modification is applied, the second version data will include multiple version data. The blockchain execution module 170 of the node 100A may execute the research note file by combining the first version data with the second version data, and implement the research note stored at the second time. When the second time is the final storage time, the implemented research note may be implemented such that it includes the content of the final research note modified last.

In certain embodiments, the command for executing the research note file may be the command for executing the research note file of a particular point in time. For example, it may be a third point in time between the first point in time and the second point in time. In this case, the blockchain execution module 170 implements the research note using version data included in the range of the first point in time and the third point in time.

As described above, the system 1 may encrypt research note-related data and store it in blockchain, and when necessary, may implement the research note. Accordingly, the system 1 can have various advantages.

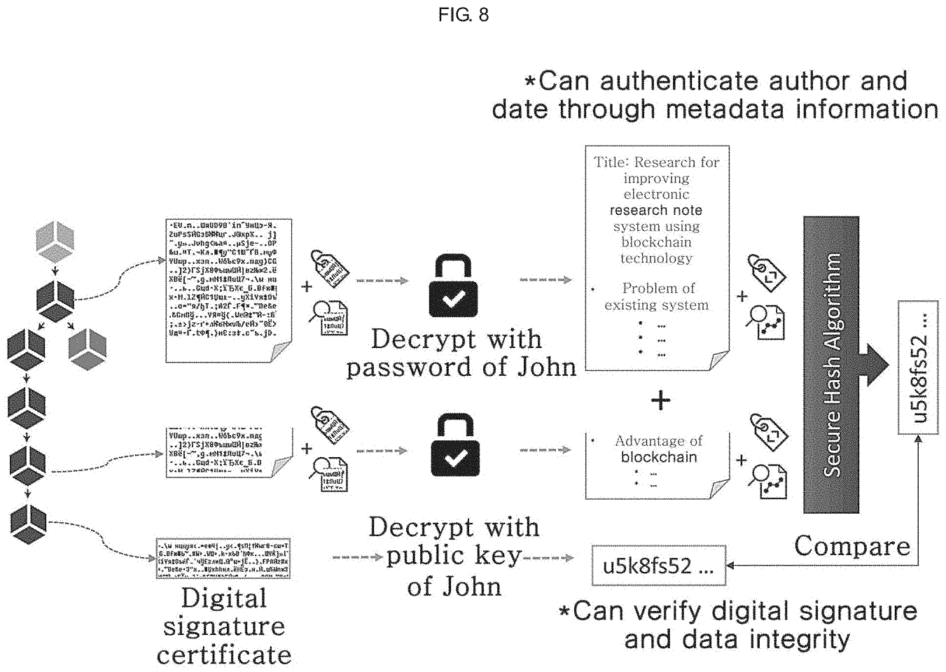

FIG. 8 is a diagram illustrating an example of use of content-related data stored in blockchain according to an embodiment of the present disclosure.

Referring to FIG. 7 again, in the S360 and S390, research note-related data newly generated from the node 100A is recorded in blockchain as transaction, and subsequently the transaction is disseminated to the other node 100B, . . . , 100N. The node having received the new transaction verifies if the new transaction is valid. Through this verification, the validity of the research note-related data included in the transaction is verified.

As shown in FIG. 8, transactions of the node 100A are disseminated to the node (100B). For example, assume that transactions of the node 100A are disseminated to node (100B). The node (100B) verifies the validity of the transactions of the node 100A by analyzing the digital signature.

In an embodiment, when a PKI based digital signature is used, the digital signature generated from the node 100A calculates a hash value of data to be verified (i.e., the raw data and metadata set of the research-related content) by applying a hash function to the data to be verified. The blockchain execution module 170 of the node 100A encrypts the hash value of the data to be verified using a private key of the node 100A to generate a digital signature for the data to be verified. The transaction including the data to be verified and the digital signature is stored in blockchain, and disseminated to node (100B) through the storage process. The node (100B) having received the data to be verified and the digital signature calculates a decryption hash value of the digital signature by decrypting the digital signature with a public key of the node 100A. The blockchain execution module 170 of the node 100B calculates a hash value by applying a hash function to the data to be verified of the node 100A and compares it with the decryption hash value. As a result of comparison, when the two hash values calculated by the node 100B match, the transaction disseminated from the node 100A is verified as valid.

Here, decryption of the digital signature with the public key of the node 100A does not affect the access authority to read and use the research note file of the node 100A. As shown in FIG. 8, when the access authority to the research note file of the node 100A is limited by the password, the node 100B may additionally perform a task of decrypting the encryption for confidentiality to read or use the research note file of the node 100A. In this case, the task of decrypting the encryption for confidentiality is performed before applying the hash function to the data to be verified.

As described above, when research note-related data is stored in blockchain, the validity of data related to the stored research note file is automatically verified, and thus the blockchain storage result may be usefully exploited in legal and moral conflicts that may occur in relation to research for which the corresponding research note file is made.

Additionally, the system 1 allows the user of the node 100A having stored research-related information in blockchain as well as other user of the system 1 to read and use the corresponding research note more easily.

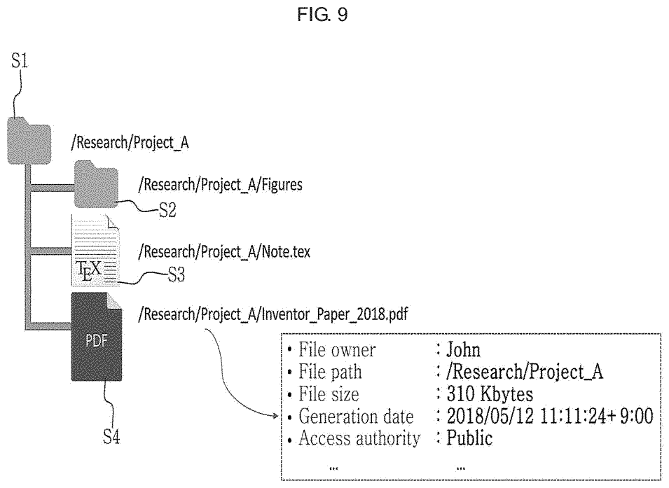

FIG. 9 is a diagram illustrating an example of use for publication of a file stored in blockchain according to an embodiment of the present disclosure.

In an embodiment, the node 100A may not perform the encryption for confidentiality on the research note file. In this case, the node 100B having received transaction including data related to the corresponding research note file can perform a task of implementing the research note of the node 100A included in the transaction and using it such as reading and modifying. In another embodiment, the node 100A may perform the encryption for confidentiality requiring decryption differentially for each task. For example, research note-related data may be encrypted so that decryption for confidentiality is not required for the task of reading the research note of the node 100A by other node 100B, but decryption for confidentiality is required for the task of using the research note file such as modification.

The above-described encryption task may be performed for each file in the sync folder. As shown in FIG. 9, access authority may be set to allow other user to read only PDF files in the sync folder (Research).

When the condition is satisfied through the authority given as described above, node 100B other than the node 100A having written the research note may execute the corresponding research note file. The execution by the node 100B is similar to the task of executing the research note file by the node 100A, and its detailed description is omitted herein.

As described above, the system 1 gives the authority to read/write the research notes stored in blockchain to other user(s) differentially and equally, making it easy to do collaboration, for example, collaboratively writing the research notes. Particularly, it is possible to facilitate the collaboration with external users (e.g., external institutions and foreign countries) of groups (e.g., institutions such as research laboratories and companies, subgroups such as departments and teams, etc.) to which users belong.

In addition, the node 100A may have use for storing a different type of data in blockchain, rather than storing the full content of the research note file in blockchain.

In an embodiment, the node 100A may upload raw data of the research note file to a database node 200, and store data (e.g., a URL of the uploaded data, etc.) for accessing the uploaded data in blockchain. In this case, it is necessary to additionally store data (e.g., a hash value of the uploaded content file) for verifying the validity of the uploaded data in blockchain.

Here, the database node 200 refers to cloud database computing resources in which applications and data are stored in a remote server, like Simple Storage Service (S3) provided by Amazon.Com, Inc., Google File System (GFS) provided by Google Inc., or Microsoft Office Online provided by Microsoft Corporation.

In another embodiment, when a file is stored in the sync folder for the first time after the research note file is initially generated, the method may be designed not to perform the S330 of comparing.

The operation by the system and method according to the embodiments as described above may be, at least in part, implemented as a computer program and recorded on computer-readable recording media. For example, it may be implemented together with program products implemented as computer-readable media including program code, and may be executed by the processor for performing any or all steps, operations, or processes described herein.

The computer-readable recording media includes any type of recording and identification device in which computer-readable data is stored. Examples of the computer-readable recording media include ROM, RAM, CD-ROM, magnetic tape, floppy disk and optical data storage and identification devices. Additionally, the computer-readable recording media is distributed over computer systems connected via a network so that computer-readable codes may be stored and executed in distributed manner. Additionally, functional programs, codes and code segments for realizing this embodiment will be easily understood by those having ordinary skill in the technical field to which this embodiment belongs.

The present disclosure has been hereinabove described with reference to the embodiments shown in the drawings, but this is provided for illustration purposes only and those having ordinary skill in the corresponding field will understand that various modifications and variations may be made thereto. However, it should be noted that such modifications fall within the technical protection scope of the present disclosure. Accordingly, the true technical protection scope of the present disclosure shall be defined by the technical spirit of the appended claims.

The method for managing content based on blockchain according to an aspect of the present disclosure can store and manage content being continuously modified through blockchain. Particularly, as opposed to earlier blockchain technology that is impossible to modify data stored in blockchain, there is an advantage that it is possible to modify the content of files stored in blockchain in a manner of adding the details of the modification. Additionally, it is possible to detect metadata of files stored in blockchain using one of fourth industrial revolution technologies, machine learning, in recent years.

In light of the current situation in which much attention is paid to technology using blockchain (especially, coin-related technology), it is expected that the possibility of making use of the present disclosure, the combination of content and blockchain technology, will be endless.

What is claimed is:

1. A method for managing content based on blockchain using a blockchain network including at least one node, each node including an offline storage; and a blockchain distributed storage to store a blockchain in which blocks are linked together, the method comprising:
synchronizing, by a first node, a folder in the offline storage to the blockchain distributed storage;
detecting raw data corresponding to content of a content file stored in the folder, and determining version data of the content;
generating a metadata set of the content file based on the version data;
determining data for blockchain storage based on the version data and the metadata set, and encrypting the data for blockchain storage; and
storing transaction including the encrypted data in the blockchain.

2. The method according to claim 1, wherein the determining the version data comprises:
when a predetermined command for the content file is received, comparing content files before and after the command—the comparing is performed by comparing first raw data corresponding to the content before the command with second raw data corresponding to the content after the command;
when there is no difference between the first raw data and the second raw data, detecting the first raw data and determining it to be version data; and
when there is a difference between the first raw data and the second raw data, detecting data corresponding to the raw data difference before and after the command and determining it to be version data.

3. The method according to claim 2, wherein when there is a difference between the first raw data and the second raw data, the metadata set of the content file after the command is updated based on the version data of the difference between the first raw data and the second raw data.

4. The method according to claim 2, wherein a block including the transaction related to the version data before the command is different from a block including the transaction related to the version data after the command.

5. The method according to claim 1, further comprising:
when a command for executing the content file is received, retrieving transaction related to the content file from the blockchain;
decrypting encrypted data included in the found transaction; and
executing the content file using the decrypted data.

6. The method according to claim 5, wherein the executing the content file comprises, in the case of one or more found transactions, executing the content file by combining version data of each transaction.

7. The method according to claim 1, wherein the encrypting comprises encrypting for verification.

8. The method according to claim 7, wherein each node has a private key and a public key, and the encrypting for verification comprises encrypting the data for blockchain storage using the private key.

9. The method according to claim 6, wherein the encrypting comprises encrypting for confidentiality, and the encrypting for confidentiality comprises encrypting using a password preset for each node.

10. The method according to claim 9, further comprising:
providing, by the first node, an authority to use the encrypted data for confidentiality to the second node.

11. The method according to claim 10, wherein the second node is located in a foreign country.

12. The method according to claim 1, wherein the data for blockchain storage includes version data corresponding to modification time of the content.

13. The method according to claim 1, wherein the metadata set includes basic metadata, and the basic metadata includes a file owner, a file path on the offline storage, generation time and access authority.

14. The method according to claim 1, wherein the metadata set includes content metadata, and the content metadata is detected from the content of the content file by a content analysis model.

15. The method according to claim 15, wherein the content analysis model is based on rapid automatic keyword extraction (RAKE) or Term Frequency-Inverse Document Frequency (TF-IDF).

16. The method according to claim 1, wherein the storing in the blockchain comprises:
recording the transaction in an available block included in the blockchain; and
disseminating the transaction to a second node.

17. The method according to claim 1, wherein the data for blockchain storage further includes access data for access to the version data.

18. The method according to claim 17, further comprising:
uploading the version data to a database node.

19. A non-transitory computer-readable recording medium which is readable by a computer and in which a program command that can run by the computer is stored, to enable a processor of the computer to perform the method according to claim 1 when the program command is executed by the processor.

20. A system for managing content based on blockchain using a blockchain network including at least one node, each node including a data processing module, a blockchain execution module, an offline storage and a blockchain distributed storage to store a blockchain in which blocks are linked together, and configured to perform the steps of:
detecting, by the data processing module, raw data corresponding to content of a content file stored in the folder, and determining version data of the content; and generating a metadata set of the content file based on the version data, and
determining, by the blockchain execution module, data for blockchain storage based on the version data and the metadata set, and encrypting the data for blockchain storage; and storing transaction including the encrypted data in the blockchain.
